(19) United States
(12) Patent Application Publication
(10) Pub. No.: US 2014/0231339 A1
(43) Pub. Date: Aug. 21, 2014

(54) High Viscosity TFF Device Design

(71) Applicant: EMD Millipore Corporation, Billerica, MA (US)

(72) Inventors: Clifton Ngan, Chelmsford, MA (US); Yu Zou, Malden, MA (US); Brian Hillier, Lowell, MA (US); Andrew Bartlett, Lowell, MA (US)

(21) Appl. No.: 14/348,968

(22) PCT Filed: Dec. 10, 2012
(86) PCT No.: PCT/US12/68755

§ 371 Date: Apr. 1, 2014

Related U.S. Application Data
(60) Provisional application No. 61/568,882, filed on Dec. 9, 2011.

(51) Int. Cl. B01D 35/28

(52) U.S. Cl. CPC B01D 35/28
USPC 210/499

(57) ABSTRACT

A device for the tangential filtration of liquids at high viscosities is taught. For a given channel length and width (relatively fixed by the cassette design), one can decrease the channel pressure drop by increasing the channel height or reducing the channel hydraulic resistance. One can increase the channel height by using a larger diameter fiber in the screen, by increasing the thickness of the molded border or nm on the overmolded screen or by using a thicker nonwoven as a spacer in a non-overmolded screen. Since the screen is embossed into the surface of the membrane: the effective channel height Is also affected by the hardness of the membrane -as well as the fibers In the screen.

The present application claims the benefit of priority of U.S. Provisional Patent Application No. 611568,882, filing date Dec. 9, 2011, of which is incorporated by reference herein in its entirety.

The present invention relates to a device for tangential flow filtration (TFF). More particularly, it relates to a feed screen for a TFF device used with high viscosity fluids.

### BACKGROUND OF THE INVENTION

Membrane-based tangential flow filtration (TFF) cassettes are used for the clarification, concentration and purification of fluid streams containing macromolecules of proteins. In TFF, the protein fluid is pumped tangentially along the surface of the membrane. An applied pressure series to force a portion of the feed stream through the membrane surface to the filtration side. Particles and macromolecules are retained to the retentate side. The feed flow along the length of channel between two membranes causes a pressure drop from the feed to the retentate end of the channel. During concentration of a protein solution, the pressure drop from the feed side to the retentate side of the TFF cassettes increases with the increase of solution viscosity; meanwhile, flux, which is defined by the volume flow normalized for membrane area it passes through, decreases as solution viscosity becomes higher.

Membrane spacers such as screens are an essential part of TFF modules that significantly influence the mass transfer performance and pressure drop. The screens are turbulence generators that increase the mass transfer rate because of enhanced wall shear stress and addy promotion. However, they also increase the pressure drop down the channels between the feed port(s) and the retentate port(s).

The TFF devices are available with different screens to accommodate feed streams with low and high viscosity. Cassettes are available generally with a coarse screen and a fine screen. Additionally, some cassettes are available with a “suspended” screen consisting of a coarse screen placed between nonwoven shims to increase the distance between the screen and the membrane surface.

During concentration of a protein solution, for example, the final concentration is now limited by either the discharge pressure of the pump (around 50 psi for a peristaltic pump), or the pressure rating of the cassette or some other component in the system, say 80 or 90 psi. As a result, it is difficult to obtain high final concentrations, say greater than 200 or 250 g/L.

With the current cassette designs there is a large difference in performance between the coarse screen devices and the suspended screen devices. While the suspended screen device does have a substantially lower pressure drop due to the open channel formed by the nonwoven spacer, the mass transfer rate is severely reduced due to the open-channel nature from the nonwoven spacers.

Some of these devices appear to be capable of handling high viscosity solutions using a coarse mesh screen. Most have a performance that has a high pressure drop. Some have a slightly lower pressure drop due to the use of a “suspended screen design containing a gap” but they also suffer from lower mass transfer at the high concentration.

In order to allow operation to higher concentrations and higher viscosities, there is a need to provide a cassette with reduced channel pressure drop while maintaining a relatively high mass transfer rate.

The present invention provides an improved design of TFF devices to better handle high viscosity streams.

### SUMMARY OF INVENTION

A device for the tangential filtration of liquids at high viscosities is taught. For a given channel length and width (relatively fixed by the cassette design), one can decrease the channel pressure drop by increasing the channel height or reducing the channel hydraulic resistance. One can increase the channel height by using a larger diameter fiber in the screen, by increasing the thickness of the molded border or rim on the overmolded screen or by using a thicker nonwoven as a spacer in a non-overmolded screen. Since the screen is embossed into the surface of the membrane, the effective channel height is also affected by the hardness of the membrane as well as the fibers in the screen.

It is an object of the present invention to provide a screen having a length, a width and a thickness between a first upper surface and a second lower surface, and the screen having one or more features selected from the group consisting of a rim attached to an outer periphery of the screen, wherein the rim is of a height of at least 2 mil to 8 mil above the height of the first and second surfaces on each side of the screen; a twill weave design; a fiber diameter of greater than 215 micron to 360 microns; an orientation of the warp of the screen to flow direction of from −10 degrees or greater than +10 degrees to 100 degrees; a mesh count in the screen from about 10.6 to about 20 n/cm; a combination of a rim attached to an outer periphery of the screen, wherein the rim is of a height of at least 2 mil to 8 mil above the height of the first and second surfaces on each side of the screen and a fiber diameter of greater than 215 microns to 360 microns; a combination of a rim attached to an outer periphery of the screen, wherein the rim is of a height of at least 2 mil above the height of the first and second surfaces on each side of the screen, a fiber diameter of greater than 215 microns to 360 microns and a twill weave pattern; a combination of a rim attached to an outer periphery of the screen, wherein the rim is of a height of at least 2 mil above the height of the first and second surfaces on each side of the screen, a fiber diameter of greater than 215 microns to 360 microns; a combination of a rim attached to an outer periphery of the screen, wherein the rim is of a height of at least 2 mil above the height of the first and second surfaces on each side of the screen, a fiber diameter of greater than 215 microns to 360 microns; and an orientation of the warp of the screen to flow direction of from −10 degrees or greater than +10 degrees to 100 degrees; a combination of a rim attached to an outer periphery of the screen, wherein the rim is of a height of at least 2 mil above the height of the first and second surfaces on each side at the screen, a fiber diameter of greater than 215 microns to 360 microns, an orientation of the warp of the screen to flow direction of from −10 degrees or greater than +10 degrees to 100 degrees and a mesh count in the screen from about 10.6 to about 20 n/cm

It is another object of the present invention to provide a screen has a rim attached to an outer periphery of the screen, wherein the nm is of a height of at least 2 mil above the height of the first and second surfaces on each side of the screen.

It is an additional object of the present invention to provide a feed screen wherein the screen has a twill weave design.

It is a further object of the present invention to provide a feed screen with a twill weave design of two under and one over in the warp direction.

It is another object of the present invention to provide a feed screen having a fiber diameter of greater than 215 microns to 360 microns.

It is an additional object of the present invention to provide a feed screen wherein the screen has an orientation of the warp of the screen to flow direction of from −10 degrees or greater than +10 degrees to 100 degrees.

It is a further object of the present invention to provide a feed screen wherein the screen has a combination of a rim attached to an outer periphery of the screen. wherein the rim is of a height of at least 2 mil above the height of the first and second surfaces on each side of the screen and a fiber diameter of greater than 215 microns to 360 microns

It is another object of the present invention to provide a feed screen wherein the screen has a combination of a rim attached to an outer periphery of the screen, wherein the rim is of a height of at least 2 mil above the height of the first and second surfaces on each side of the screen, a fiber diameter of greater than 215 microns to 360 microns and a twill weave pattern.

It is an additional object of the present invention to provide a feed screen wherein the screen has as combination of a rim attached to an outer periphery of the screen, wherein the nm is of a height of at least 2 mil above the height of the first and second surfaces on each side of the screen, and a fiber diameter of greater than 215 microns to 360 microns.

It is another object of the present invention to provide a feed screen wherein the screen has a combination of a rim attached to an outer periphery of the screen, wherein the rim is of a height of at least 2 mil above the height of the first and second surfaces on each side of the screen, a fiber diameter of greater than 215 microns to 360 microns; and an orientation of the warp of the screen to flow direction of from −10 degrees or greater than +10 degrees to 100 degrees.

It is a further object of the present invention to provide a feed screen wherein the screen material is selected from the group consisting of polypropylene and polyethylene terephthalate.

It is an additional object of the present invention to provide a feed screen wherein the screen has a mesh count from about 10.6 to about 20 n/cm.

### BRIEF DESCRIPTION OF THE DRAWINGS

FIG. 1 shows pressure drop of TFF cassettes including those of the present invention using different feed screens vs. the concentration of feed stream bovine gamma globulin (BgG).

FIG. 2 shows flux vs. the concentration of feed stream BgG of different feed screens of TFF cassettes including those of the present invention.

FIG. 3 shows mass transfer coefficient of TFF cassettes of different feed screens including those of the present invention.

FIG. 4A shows a planar top down view of a feed screen according to the present invention with rim border.

FIG. 4B shows a cross-sectional view taken on lines 4A of the feed screen of FIG. 4A.

FIG. 5 shows pressure drop vs. concentration of TFF cassettes using C screen vs. C+3 screen of the present invention.

FIG. 6 shows flux vs. the concentration of TFF cassettes using C screen vs. C+3 screen of the present invention.

FIG. 7 shows pressure drop vs. concentration of TFF cassettes using PET C screen and PET C+3 screen of the present invention.

FIG. 8 shows flux vs. concentration of TFF cassettes using PET C screen and PET C+3 screen of the present invention.

FIG. 9 shows pressure drop vs. concentration of TFF cassettes using different screen orientations of TFF cassettes including those of the present invention.

FIG. 10 shows flux vs. concentration of TFF cassettes using different screen orientations flux vs. concentration of TFF cassettes using different screen orientations of TFF cassettes including those of the present invention.

FIG. 11 shows mass transfer coefficient of TFF cassettes of different screen orientations of TFF cassettes including those of the present invention.

FIG. 12 shows pressure drop vs. concentration of TFF devices designed with inventive method.

FIG. 13 shows flux vs. concentration of TFF devices designed with inventive method.

FIG. 14 shows mass transfer coefficient of TFF devices designed with inventive method.

FIG. 15 shows the ratio of pressure drop at 200 g/L concentration to mass transfer coefficient of TFF cassettes including those of the present invention.

### DETAILED DESCRIPTION OF THE PREFERRED EMBODIMENTS

Several approaches are possible under the present invention. For a given channel length and width (relatively fixed by the cassette design), one can decrease the channel pressure drop by increasing the channel height or reducing the channel hydraulic. resistance. One can increase the channel height by using a larger diameter fiber in the screen, by increasing the thickness of the molded border or rim on the overmolded screen or by using a thicker nonwoven as a spacer in a non-overmolded screen. Since the screen is embossed into the surface of the membrane, the effective channel height is also affected by the hardness of the membrane as well as the fibers in the screen.

The major part of the invention is focused on the new design of the feed screen, which is known to have a significant influence on both the mass transfer rate and pressure drop. It includes inserting a new screen which has new features in mesh diameter, mesh opening size, mesh count, weave pattern, screen thickness, and the like.

In some embodiments according to the invention, a design for the increased rim height of the feed screen is provided to reduce the pressure drop in the TFF channel. The rim height of the feed screen is produced by overmolding the screen and the rim height is determined by the feed screen mold.

The present invention also includes changing the orientation of the screens. The screens are oriented at an angle to the tangential flow preferably about −10 degrees from the flow direction or >than 10 degrees up to about 100 degrees. The weave pattern of the screens is preferably a twill weave (over two, under one). By changing the orientation of the screens, it will affect the fluid dynamics in the channel and thus influence the pressure drop and mass transfer.

The present invention also includes using a material that is hard for the screen such as polypropylene or polyethylene terephthalate. Other materials having similar hardnesses would also be acceptable. It is preferred that the screen be made of a thermoplastic so it can be overmolded to a thermoplastic outer rim as described herein.

The combination of overmolded rim height above the surface of the screen and improved screen design provides a TFF device with significantly reduced pressure drop and less reduced mass transfer even at high viscosities. Typically, screens are changed to improve permeability at the expense of mass transfer. Conversion of the coarse screen to a screen of the present invention with special screen design improves permeability by a factor of 2, but reduces the mass transfer coefficient (k) by 30%. The use of a rim height in the overmolded screen of 3.5/1000 of an inch, provides improved permeability of the device by more than a factor of 2, with a mass transfer coefficient 17% higher than achieved by simply changing the screen. The unique combination of an improved screen with the overmolded rim height; can further reduce the pressure drop while maintaining a high mass transfer coefficient. In this way, novel materials with improved performance attributed to a unique and surprising relationship between permeability and mass transfer as demonstrated by the pressure drop/mass transfer coefficient ratios shown in Table 1.

The range of mesh diameter varies from 215 to 360 microns, and the mesh count varies from 20 to 10.6 n/cm. The rim height of screens varies from 2/1000 of an inch to 8/1000 of an inch on each side.

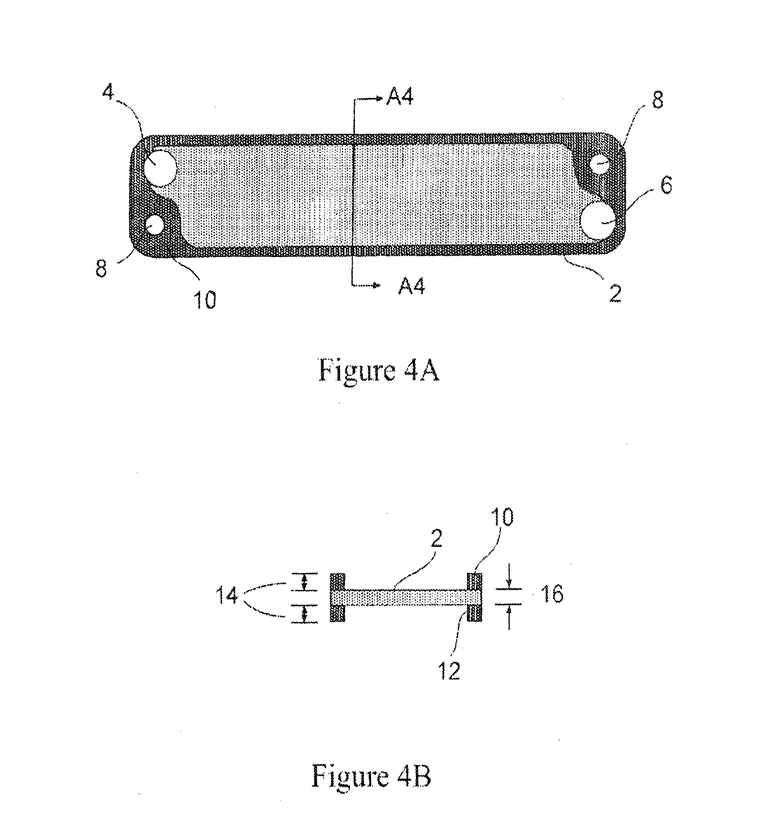

FIGS. 4A and 4B show a screen with the rim height detail of the present invention. As shown in FIG. 4A the screen has an outer rim formed and joined to its outer periphery as will be described below in more detail. As shown, the screen 2 is to be used for a TFF device having feed 4, retentate 6 and permeate 8 ports. A rim 10 is formed around the outer periphery of the screen 2. As shown for a TFF feed screen the permeate ports 8 are also sealed off by the rim from the screen 2 and the feed and retentate ports 4, 6. As shown in FIG. 4B, the rim 10 and screen 2 are preferably bonded to each other and the rim 10 preferably has a height 14 greater than the thickness 16 of the screen 2. As shown the rim 10 has a height 14 of equal amount on each side of the screen 2.

The molded rim height 14 is formed by the molding or bonding of an inner portion of the rim 10 to the outer portion of the screen 2. Preferably, the rim 10 is injection molded to the edge of the screen 2. The rim 10 may be formed on one or both sides of the screen as desired. Preferably it 10 is formed as one injection-molded piece on both sides of screen 2. To form such a outer rim 10, two molds each corresponding to a half of the final screen 2 with rim design are made and placed on opposite sides of feed screen in alignment with each other. Molten thermoplastic or other selected material is then injected into either one or both mold pieces and fills the mold with the rim material, thus forming the desired rim 10 in place on the screen 2.

l Alternatively, if desired, the rim portion 10 may be pre-molded and the screen 2 attached to the opening in the rim by various means such as adhesives or a mechanical retention of the screen 2 such as by a press fit of the screen 2 within the opening of the rim 10 or by melt bonding the screen 2 into the rim 10.

Suitable materials for the rim 10 include but are not limited to thermoplastics, such as polyethylene, polypropylene, EVA copolymers, alpha olefins and metallocene copolymers, PFA, MFA, polycarbonate, vinyl copolymers such as PVC, polyamides such as nylon, polyesters, acrylonitrile-butadienestyrene (ABS), polysulphone, polyethersulphone, polyarylsulphone, polyphenylsulphone, polyacrylonitrile, polyvinylidene fluoride (PVDF), and blends thereof, thermoplastic elastomers such Santoprene® polymer, EPDM rubber, thermosets such as closed cell foamed urethanes, and rubbers, either natural or synthetic.

It is preferred that the material be a thermoplastic or thermoplastic elastomer so as to allow for its use in the preferred method of this invention, injection molding. Preferred thermoplastics include low density, linear low density, medium density and high density polyethylene, polypropylene and EVA copolymers.

A module using a screen according to the present invention is typically formed in the following manner: a screen, preferably a feed screen is formed with a rim, preferably a thermoplastic rim that extends above at least one, preferably both of the major surfaces of the screen.

In a tangential flow filtration apparatus using the screen of the present invention, the feed, retentate and filtrate ports are arranged so that the incoming fluid feed to the apparatus enters at least one feed channel, passes through the feed screen layer(s) and either passes through a membrane to form a filtrate stream or is retained by a membrane to form a retentate stream. The retentate stream is removed from the device through the one or more retentate ports and the filtrate stream is removed through the one or more filtrate ports. If desired, one or more filtrate inlet ports and one or more filtrate outlet pods can be formed so that some filtrate is recycled to the filtrate layer inlet port to effect tangential flow on the filtrate side. This may also be done on the retentate side instead of on the filtrate side or on both sides to increase tangential flow efficiency of the device. By doing so, one may control the transmembrane pressure within the device.

TABLE 1
Pressure drop vs. Mass transfer coefficient for inventive method
compared to current state of the art. Screen characteristics
(A, C, D2 and D3) are listed in Table 2 below.

| | Pressure | | |
|---|---|---|---|
| | Drop at 200 g/L | | Ratio of |
| | bovine gamma | | Pressure |
| | globulin | | Drop to |
| | (BgG) and 8 | Mass Transfer | Mass |
| | LMH cross | Coefficient k | Transfer |
| Device | flow rate (psi) | (LMH) | Coefficient |
| Sartorius Hydrasart | 57.8 | 20.6 | 2.8 |
| Standard Device with | 117 | 29.5 | 4.0 |
| C Screen | | | |
| Standard Device with | 62.5 | 23.1 | 2.7 |
| D2 Screen | | | |
| Standard Device with | 54.6 | 20.7 | 2.6 |
| D3 Screen | | | |
| Inventive Device with | 50 | 23.4 | 2.1 |
| C Screen with | | | |
| increased nm height | | | |
| only | | | |
| Inventive Device with | 43 | 22.3 | 1.9 |
| D2 Screen with larger | | | |
| mesh diameter, | | | |
| smaller mesh count | | | |
| and increased nm | | | |
| height | | | |
| Inventive Device with | 23 | 16 | 1.4 |
| D3 Screen with larger | | | |
| mesh diameter, | | | |
| smaller mesh count | | | |
| and increased nm | | | |
| height (predicted) | | | |

in various embodiments, the claimed features are useful to reduce the pressure drop from the feed ports to the retentate ports and in the meanwhile, remain good mass transfer performance. A device where the ratio of pressure drop at 200 g/L bovine gamma globulin (BgG) to the mass transfer coefficient is <2.2 is preferred.

### Examples

### Example 1

### Comparison of Different Feed Screen

A screen and C screen are currently used in Pellicon® 3 cassettes. To accommodate feed streams with high viscosity, a new screen is introduced in the TFF cassettes. The new screen herein called the D2 and D3 screens have a larger wire diameter, less mesh count, greater mesh opening, and larger screen thickness than traditional screens. The weave pattern of D2 and D3 screens are twill weave (over two under one) and the material used for all the screens is polypropylene (PP). The comparison of D2, D3, A, C screens are shown in Table 2. All cassettes are Ultracel® 30kD 0.11 m² TFF devices.

TABLE 2
Comparison of Physical Properties A, C, D2 and D3 screens of
Table 1

| | | | | | | | | Avg |
|---|---|---|---|---|---|---|---|---|
| | Mesh | | Mesh | Wire | Basis | | Bulk | Void |
| | opening | Open | Count | Diameter | Weight | Thickness | density | Fraction |
| Screen | micron | Area % | n/cm | micron | g/m2 | micron | g/cm3 | fraction |
| A | 297 | 34 | 20 | 215 | 125 | 420 | 0.298 | 0.67 |
| C | 350 | 32 | 16.2 | 270 | 160 | 515 | 0.381 | 0.58 |
| D2 | 500 | 36 | 12.2 | 340 | 180 | 610 | 0.429 | 0.52 |
| D3 | 590 | 39 | 10.6 | 360 | 170 | 645 | 0.405 | 0.55 |

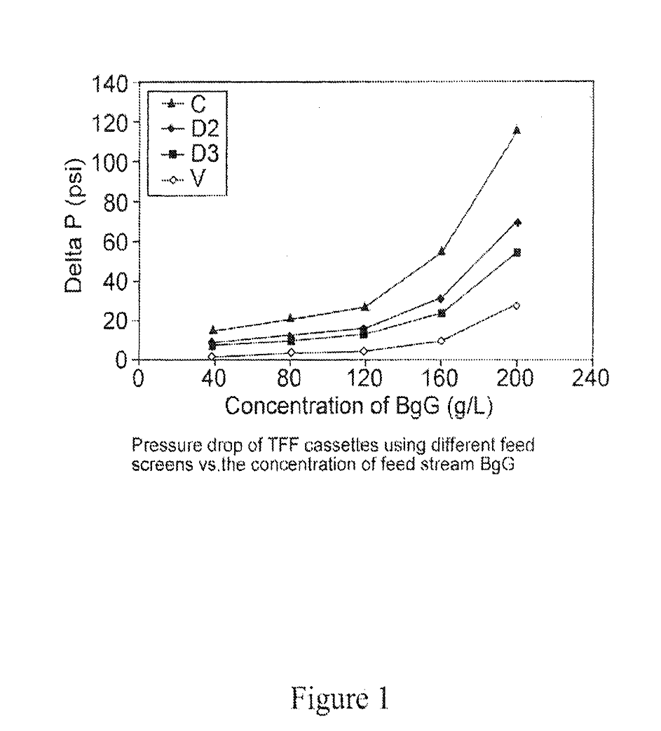

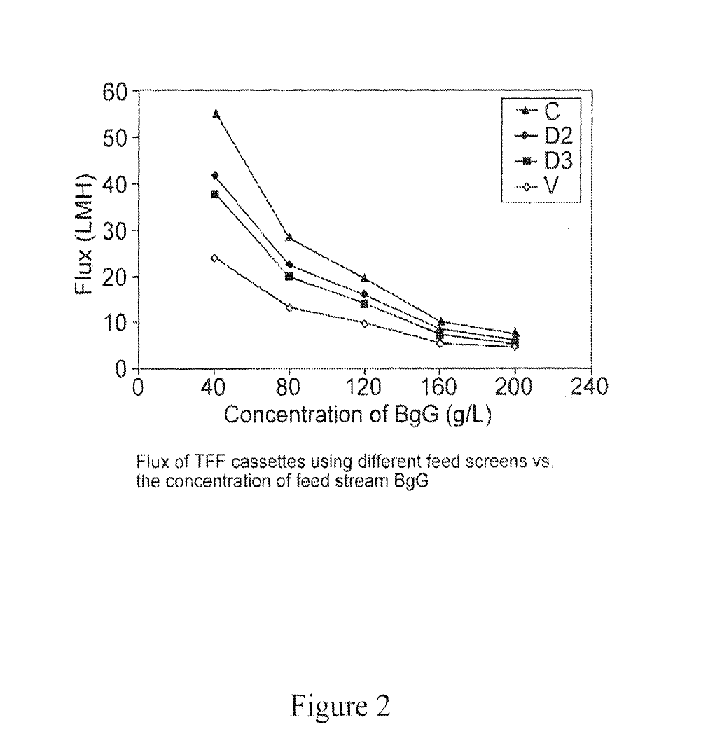

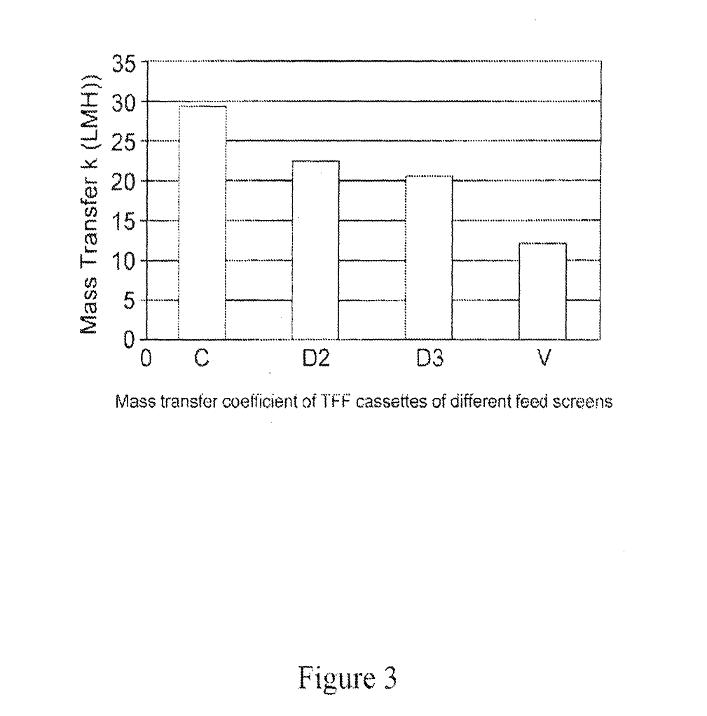

The performances of different screens are shown in FIG. 1-3.

### Example 2

### Influence of Feed Screen with Different Rim Height

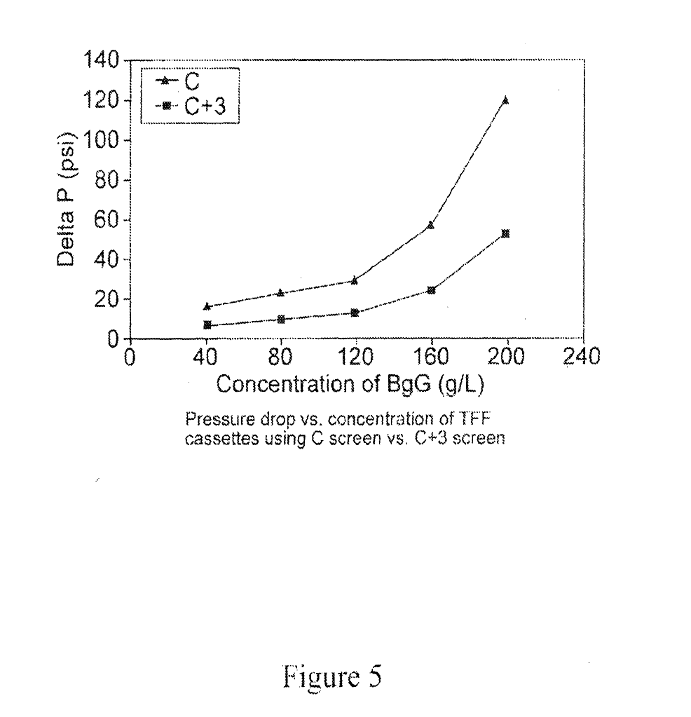

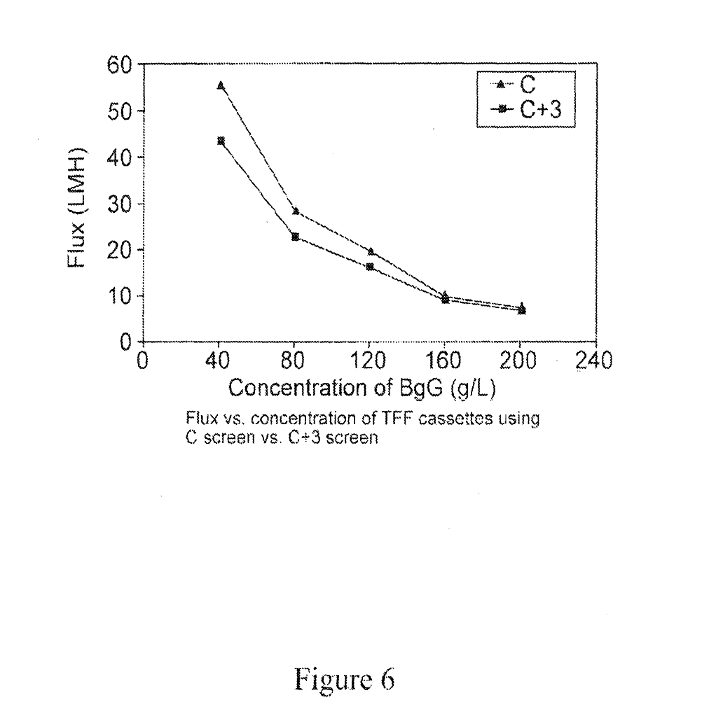

Feed screen with an increased rim height is used in the TFF cassettes as shown in FIGS. 4A and 4B and discussed above. The standard current standard rim height of a C screen is 2/1000 inch of each side. The C screen with an increased rim height of 3.5/1000 inch of each side, or the “C+3 screen”, is used to replace standard C screen, and the results for both C screen and C+3 screen are shown for comparison. All cassettes are using Ultracel® 30kD membrane, Results show that increased rim height of feed screen gives rise to decrease of almost 60% pressure drop and also flux decreased about 20%. The mass transfer coefficients for devices with C screen and C+3 screen are 29.5 and 23.4, respectively. The performances are shown in FIGS. 5 and 6.

### Example 3

### Increased Rim Height Works on Feed Screens of Different Materials

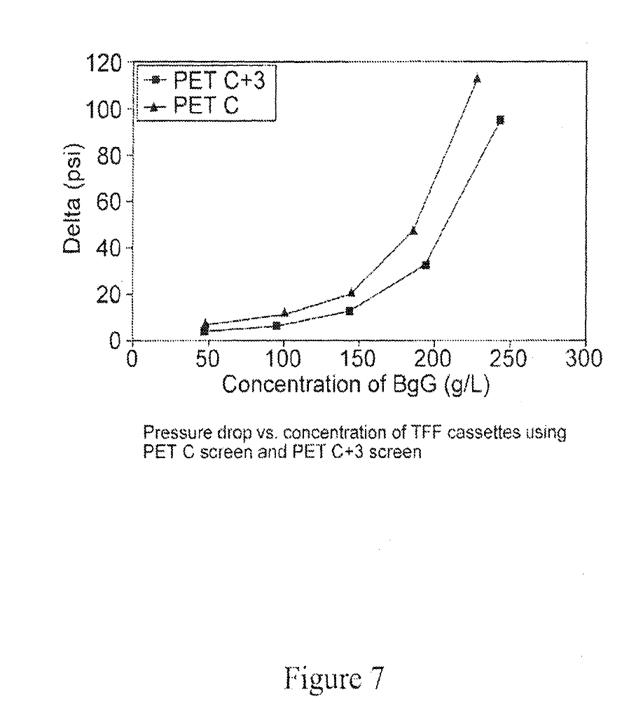

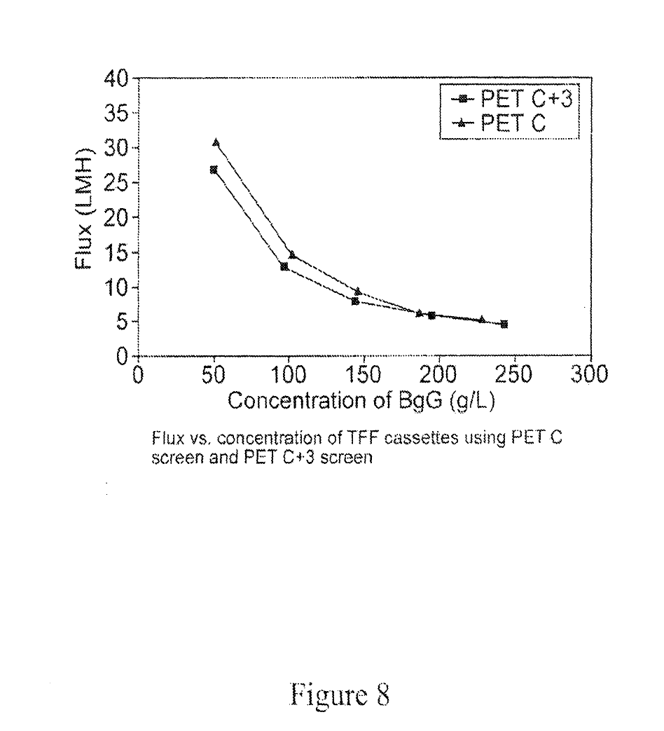

The effect of different rim height screens is applicable for screens of different materials. Instead of polypropylene (PP) screens, Polyethylene terephthalate (PET) screens with different rim heights are evaluated in the TFF cassettes. Results show that an increased rim height of PET screens has a similar effect on TFF device performance with PP screens, shown in FIGS. 7 and 8. The mass transfer coefficients for devices with PET C screen and PET C+3 screen are 17.1 and 15.5, respectively. All cassettes are using Biomax® 30kD membrane.

### Example 4

### Increased Rim Height Works on Different Membranes

Increase the rim height of feed screen can significantly lower the pressure drop which works on different membranes. The hydraulics tests of micro TFF devices of Ultracel® 30kD and Biomax® 30kD membranes using C screen and C+3 screen are shown in Table 3. The pressure drop of water for both membrane devices using different screens validates that increase screen rim height is an effective and practical method to reduce pressure drop when handling high viscosity feed stock.

TABLE 3
water pressure drop of TFF devices for Biomax ® 30 kD and
Ultracel ® 30 kD membranes using C and C + 3 screen.

| | | dP | | | |
|---|---|---|---|---|---|
| | Feed | Test - water | | Feed | dP Test - water |
| Membrane | Screens | (psi) | Membrane | Screens | (psi) |
| Biomax ® | C | 4.6 | Ultracel ® | C | 11.4 |
| 30 kD | | 5.6 | 30 kD | | 14.1 |
| | | 8.9 | | | 12.9 |
| | | 3.9 | | | 13.8 |
| | | 5.0 | | | 14.4 |
| | | 3.9 | | | 13.9 |
| | C + 3 | 2.1 | | C + 3 | 7.9 |
| | | 2.1 | | | 7.4 |
| | | 2.3 | | | 7.5 |
| | | 1.8 | | | 5.6 |
| | | 1.9 | | | 6.6 |
| | | 1.9 | | | 8.6 |

### Example 5

### Effects of Feed Screen Orientation

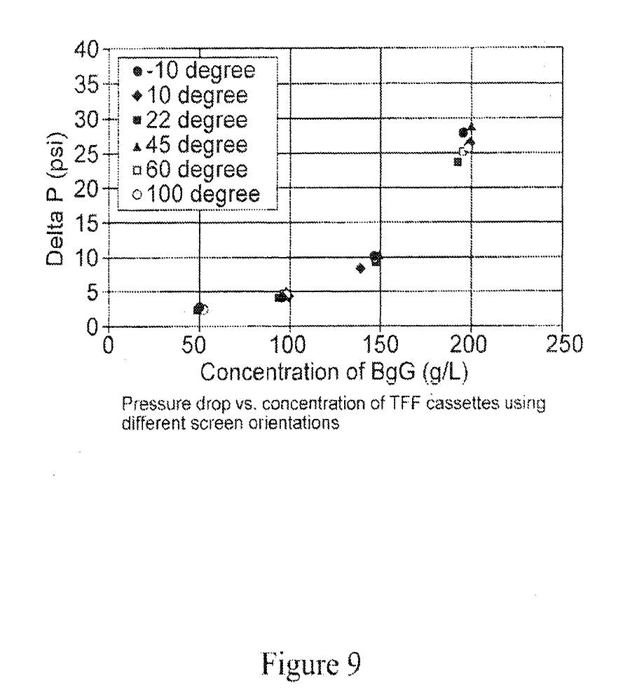

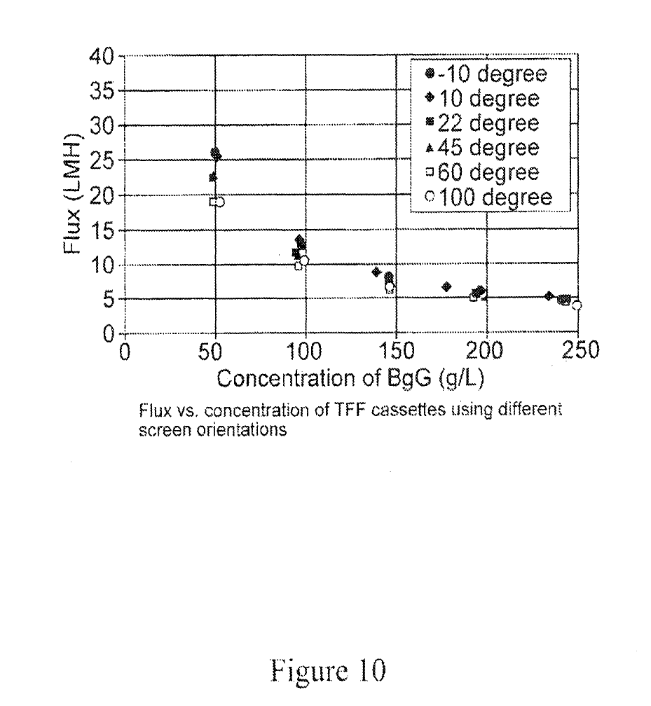

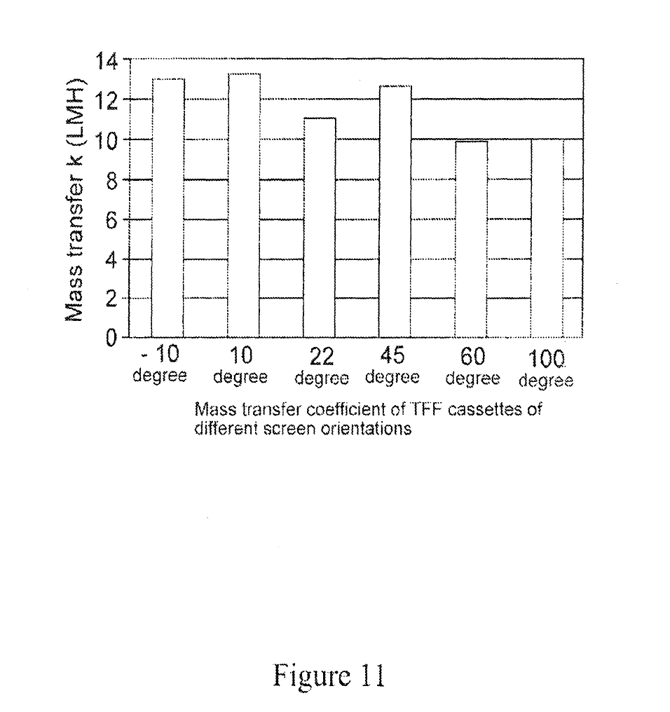

The weave pattern of feed screen is twill weave (over two under one). Changing the orientation of screen relative to flow direction will influence the obstruction to the channel and thus influence dissipating energy. Effects of feed screen orientation are evaluated using Biomax® 30kD membrane and C+3 feed screen. Angles relative to the flow direction of −10°, 10°, 22°, 45°, 60°, and 100° are chosen. Results are shown in FIGS. 9 to 11.

### Example 6

### Predicted performance of Screen, Rim Height and Screen Orientation

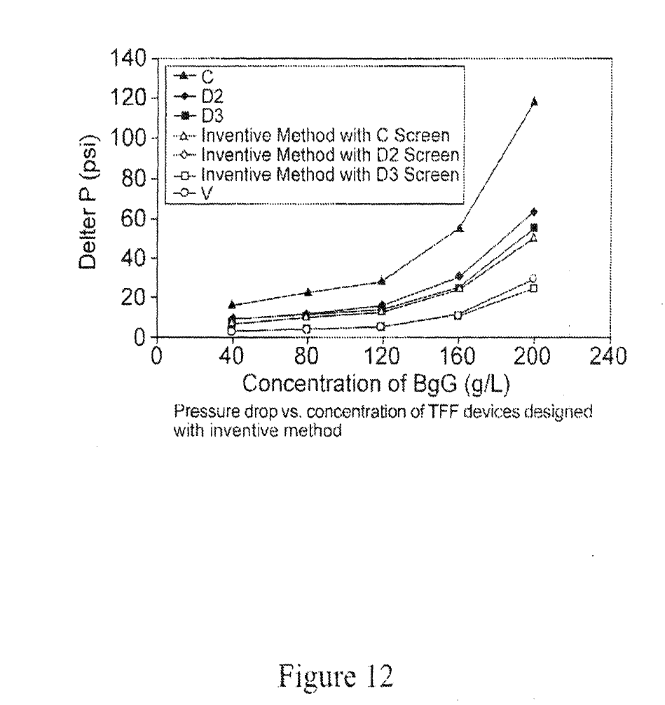

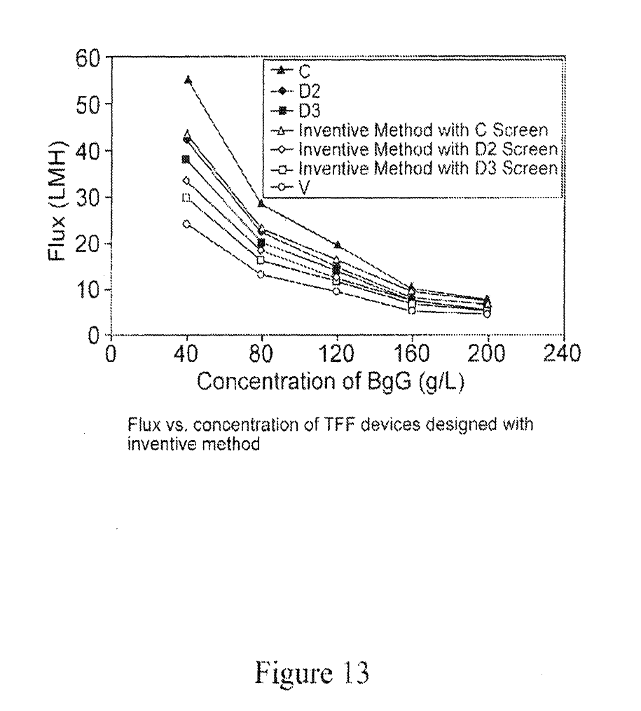

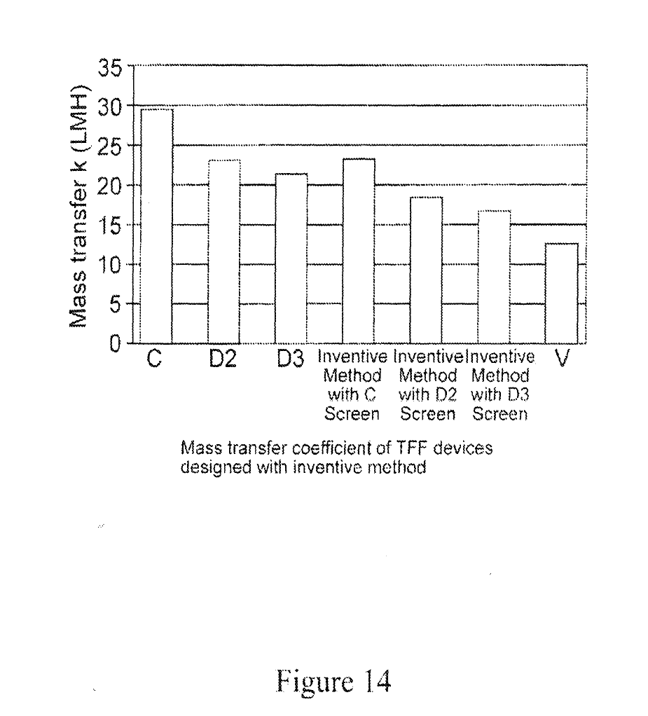

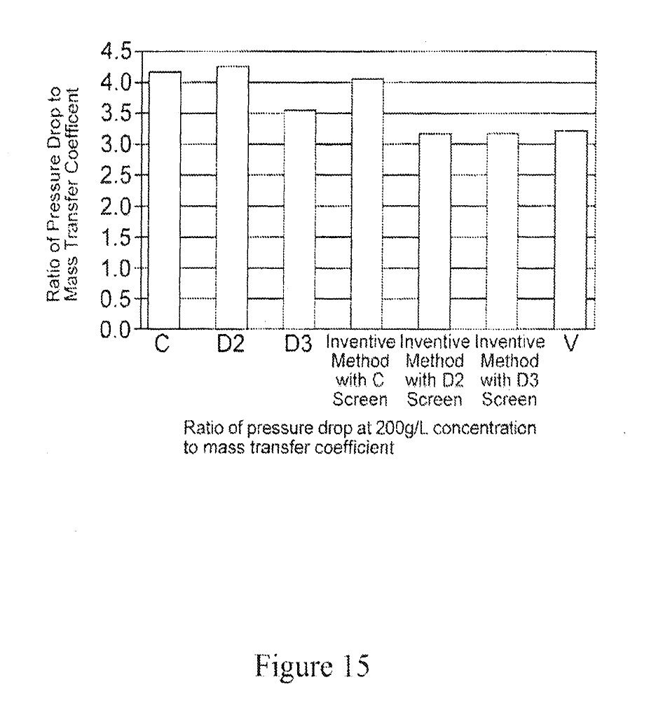

The combination of rim height, screen design and optimized screen orientation provides a UF device with significantly reduced pressure drop and less reduced mass transfer. Predicted performance of such devices using Ultracel® 30kD membranes is shown in FIGS. 12 to 15. All predictions are based on Ultracel® 30kD membrane, PP screen material and 10 degree screen orientation.

What we claim:

1. A feed screen for a tangential flow device comprising a screen having a length, a width and a thickness between a first upper surface and a second lower surface, and the screen having one or more features selected from the group consisting of a rim attached to an outer periphery of the screen, wherein the rim is of a height of at least 2 mil to 8 mil above the height of the first and second surfaces on each side of the screen; a twill weave design; a fiber diameter of greater than 215 micron to 360 microns; an orientation of the warp of the screen to flow direction of from −10 degrees or greater than +10 degrees to 100 degrees; a mesh count in the screen from about 10.6 to about 20 n/cm; a combination of a rim attached to an outer periphery of the screen, wherein the rim is of a height of at least 2 mil to 8 mil above the height of the first and second surfaces on each side of the screen and a fiber diameter of greater than 215 microns to 360 microns; a combination of a rim attached to an outer periphery of the screen, wherein the rim is of a height of at least 2 mil above the height of the first and second surfaces on each side of the screen, a fiber diameter of greater than 215 microns to 360 microns and a twill weave pattern; a combination of a rim attached to an outer periphery of the screen, wherein the rim is of a height of at least 2 mil above the height of the first and second surfaces on each side of the screen, a fiber diameter of greater than 215 microns to 360 microns; a combination of a rim attached to an outer periphery of the screen, wherein the rim is of a height of at least 2 mil above the height of the first and second surfaces on each side of the screen, a fiber diameter of greater than 215 microns to 360 microns; and an orientation of the warp of the screen to flow direction of from −10 degrees or greater than +10 degrees to 100 degrees; a combination of a rim attached to an outer periphery of the screen, wherein the rim is of a height of at least 2 mil above the height of the first and second surfaces on each side of the screen, a fiber diameter of greater than 215 microns to 360 microns, an orientation of the warp of the screen to flow direction of from −10 degrees or greater than +10 degrees to 100 degrees and a mesh count in the screen from about 10.6 to about 20 n/cm.

2. The feed screen of claim 1 wherein the screen has a rim attached to an outer periphery of the screen, wherein the rim is of a height of at least 2 mil above the height of the first and second surfaces on each side of the screen.

3. The feed screen of claim 1 wherein the screen has a twill weave design.

4. The feed screen of claim 1 wherein the screen has a twill weave design of two under and one over in the warp direction.

5. The feed screen of claim 1 wherein the screen has a fiber diameter of greater than 215 microns to 360 microns.

6. The feed screen of claim 1 wherein the screen has an orientation of the warp of the screen to flow direction of from −10 degrees or greater than +10 degrees to 100 degrees.

7. The feed screen of claim 1 wherein the screen has a combination of a rim attached to an outer periphery of the screen, wherein the rim is of a height of at least 2 mil above the height of the first and second surfaces on each side of the screen and a fiber diameter of greater than 215 microns to 360 microns.

8. The feed screen of claim 1 wherein the screen has a combination of a rim attached to an outer periphery of the screen, wherein the rim is of a height of at least 1 mil above the height of the first and second surfaces on each side of the screen, a fiber diameter of greater than 215 microns to 360 microns and a twill weave pattern.

9. The feed screen of claim 1 wherein the screen has a combination of a rim attached to an outer periphery of the screen, wherein the rim is of a height of at least 1 mil above the height of the first and second surfaces on each side of the screen, and a fiber diameter of greater than215 microns to 360 microns.

10. The feed screen of claim 1 wherein the screen has a combination of a rim attached to an outer periphery of the screen, wherein the rim is of a height of at least 1 mil above the height of the first and second surfaces on each side of the screen, a fiber diameter of greater than 215 microns to 360 microns; and an orientation of the warp of the screen to flow direction of from −10 degrees or greater than +10 degrees to 100 degrees.

11. The feed screen of claim 1 wherein the screen material is selected from the group consisting of polypropylene and polyethylene terephthalate.

12. The feed screen of claim 1 wherein the screen has a mesh count from about 10.6 to about 20 n/cm.
